(19) United States
(12) Patent Application Publication
(10) Pub. No.: US 2008/0152078 A1
(43) Pub. Date: Jun. 26, 2008

(54) Alpha and X Radiation Source, Pixe-Xrf Analysis Device Using this Source and Method for Making the Source

(75) Inventors: Jacques De Sanoit, Rungis (FR); Giuseppe Pappalardo, Acicastello (IT); Carmelo Marchetta, Catania (IT)

Correspondence Address: THELEN REID BROWN RAYSMAN & STEINER LLP, P. O. BOX 640640, SAN JOSE, CA, 95164-0640, US

(73) Assignee: ISTITUTO NAZIONALE DI FISICA NUCLEARE, FRASCATI (IT)

(21) Appl. No.: 11/918,419

(22) PCT Filed: May 3, 2006
(86) PCT No.: PCT/FR2006/050408

§ 371 Date: Oct. 12, 2007

(30) Foreign Application Priority Data
May 3, 2005 (FR) 0551160

(51) Int. Cl. G01N 23/223; H05G 1/02; H01J 35/16

(52) U.S. Cl. 378/44; 378/193; 378/203

(57) ABSTRACT

Alpha and X radiation source, PIXE-XRF analysis device using this source, and method for making the source.

The source according to the invention comprises a support (2), consisting of a chemical element for which the atomic number is less than 10 or of a plurality of chemical elements each having an atomic number less than 10, which support is covered with a layer (4) of noble metal, having a thickness less than 0.2 μm, and on which a layer of a material selected from actinides is deposited. According to the method, the layer of the material is formed by electrochemical deposition, from an organic electrolyte based on dimethyl formamide and containing ions of the material.

### TECHNICAL FIELD

The present invention relates to a source, preferably a non-contaminating source, of alpha (α) and X radiations, to a simultaneous PIXE-XRF analysis device using this source, and to a method for making such a source.

This invention is notably applicable to the making of a portable device for simultaneous PIXE-XRF analysis.

### STATE OF THE PRIOR ART

Analysis by X fluorescence of samples from various fields (notably archaeology, the environment, cultural assets and industry) by means of portable systems has been increasingly of interest since a few years. Indeed, in addition to the non-destructive character of this type of analysis, portability is imposed when experiments have to be conducted on unmovable samples.

The PIXE (Particle Induced X-ray Emission) method is a known analysis technique by X fluorescence which uses a particle accelerator as a generator of radiation.

This method has drawbacks: its application requires costly equipment and is not possible with unmovable objects or objects which are difficult to transport.

Further, portable PIXE analysis devices are known which provide a remedy to these drawbacks. These devices use non-contaminating sources of a radiation instead of a particle accelerator. The material contained in these sources is preferably polonium 210 (²¹⁰Po).

These devices are known by the following documents to which reference will be made:
[1] G. Pappalardo, J. de Sanoit, A. Musumarra, G. Calvi and C. Marchetta, Feasibility study of a portable PIXE system using a ²¹⁰Po alpha source, Nuclear Instruments and methods in Physics Research B109/110 (1996) 214-217
[2] FR 2 779 865 A, <<Source de rayonnement optimisée>>, invention of J. de Sanoit, G. Pappalardo and C. Marchetta.

These known devices have drawbacks. On the one hand, the short period of ²¹⁰Po requires half-yearly replacement of the source. On the other hand, by using a particles as an excitation radiation, it is only possible to properly identify <<light>> elements, with atomic numbers Z between 11 and 22, or <<heavy>> elements, with atomic numbers larger than 40.

On the other hand, elements with atomic numbers between 22 and 40 are very difficult to identify.

The XRF (X-Ray Fluorescence) method is another known analysis technique by X fluorescence. As an excitation source, it either uses a radioactive source, containing ¹⁰⁹Cd, ⁵⁵Fe or ²⁴¹Am, for example, or an X-ray tube. With this technique it is possible to properly analyze elements with atomic numbers larger than 22, provided that radiation of suitable energy is used. Accordingly, this method is complementary to the PIXE method.

Nevertheless, elementary analysis of a sample in the field presently requires two distinct instruments, i.e. a PIXE-α analysis instrument and an XRF analysis instrument.

### DISCUSSION OF THE INVENTION

The object of the present invention is to find a remedy to the foregoing drawbacks.

It relates to a simultaneous PIXE-XRF analysis device, this device comprising a non-contaminating radioactive source, capable of emitting not only a radiation but also X radiation.

In particular, the invention relates to such a device, comprising an intense and non-contaminating radioactive source, with a sufficiently long period at least equal to 5 years, not only emitting a radiation but also X radiation with sufficient energy, at least equal to 15 keV, this device allowing identification of elements for which the atomic numbers are larger than 10, from a same sample.

Among the possible candidates for forming the material of the source, ²⁴⁴Cm meets all the aforementioned criteria: it has a period of 18.1 years, an α emission at 5.7862 MeV and 5.804 MeV (85%) as well as X emission of average energy 17.3 keV (10.5%) from its descendant ²⁴⁰Pu.

However, another problem is posed, i.e. the problem of making a source containing ²⁴⁴Cm and, more generally, of making a source containing an actinide capable of emitting α and X radiations.

In order to make such a source, electrodeposition methods are already known which allow actinides to be deposited from aqueous solutions. But these methods have a drawback: they do not make it possible to obtain strong deposition yields for actinides.

The object of the present invention is also to find a remedy to this drawback.

Specifically, the present invention first of all relates to a source of α and X radiations, this source comprising a support consisting of a chemical element for which the atomic number is less than 10 or of a plurality of chemical elements each having an atomic number less than 10, which support is covered with a layer of noble metal, having a thickness less than 0.2 μm, and on which a layer of a material selected from actinides is deposited.

The support may be planar but it is not necessarily so.

The support included by the source, object of the invention, advantageously has the shape of a ring.

According to a preferred embodiment of the source, object of the invention, the material is ²⁴⁴Cm.

Preferably, the activity of the material is in the range from 5 MBq to 50 MBq.

The noble metal is preferably selected from gold, silver and platinum.

The present invention further relates to a simultaneous PIXE-XRF analysis device, this device comprising a source according to the invention.

Preferably, the source used in this device is non-contaminating.

In this case, according to a preferred embodiment of this device, the material is deposited on one face of the support, called an active face, this face thereby being capable of emitting α and X radiations, and the source further comprises a window which is permeable to α and X radiations, resistant to these radiations and capable of protecting the active face, this window exclusively consisting of a chemical element for which the atomic number is less than 10 or of a plurality of chemical elements each having an atomic number less than 10.

The window may be made in polyimide, in diamond or in DLC, i.e. diamond-like carbon.

The thickness of the window is preferably between 2 μm and 10 μm.

According to a preferred embodiment of the device, object of the invention, this device further comprises an X fluorescence detector.

This detector is preferably placed in proximity to the source.

According an advantageous embodiment of the device, object of the invention, the support includes an active face, on which the layer of the material selected from actinides is deposited, this support includes a hole and the detector is placed facing this hole and the face opposite to the active face.

Preferably, the support has the shape of a ring, and the detector is placed facing the hole of this ring.

By the preferential use of a source with a ring-shaped support, it is possible to position the detector behind the source, facing the aperture of the ring, and to recover the radiation re-emitted by the object, investigated in a retro-axial way. Such an assembly makes it possible to avoid detecting radiations emitted by the active face of the support of the source and it provides the advantage of being very compact.

The present invention also relates to a method for making the source, object of the invention, in which the layer of the material is formed by electrochemical deposition, from an organic electrolyte based on dimethyl formamide and containing ions of the material.

Preferably, electrochemical deposition is conducted in a galvanostatic mode.

Further, electrochemical deposition is preferably conducted at room temperature.

A method for electrochemical deposition of a material on an electrically conducting support, or made electrically conducting, from an electrolyte containing ions of the material, may also be contemplated, this method being characterized in that the electrolyte is an organic electrolyte based on dimethyl formamide.

Such a method is therefore applicable to making a source of α and X radiations, in which the material is an actinide. This method may also be used in nuclear research.

A source of α and X radiations may be formed with such a method, this source comprising a support, which is made in a metal or covered with a layer of this metal, and a material selected from actinides and deposited on the support by this electrochemical deposition method.

Such a source is therefore applicable most particularly to simultaneous PIXE-XRF analysis but may be applied to other fields of nuclear research.

In such a source, stainless steel may be used as a metal for forming or covering the support but cannot be used in an application of the source to PIXE-XRF detection as it contains nickel, chromium and iron which induce a parasitic fluorescence. This is why a noble metal is used for such an application.

Further, a solid metal support would induce a too large parasitic fluorescence signal in the application to PIXE-XRF analysis. This is why a support covered with a fine metal layer (in a noble metal according to a preferred embodiment), which makes the support conducting, while being sufficiently not very thick in order not to induce an interfering parasitic fluorescence signal, is preferably used.

Of course, ²⁴⁴Cm sources are already known, allowing simultaneous application of PIXE and XRF analyses. These sources are described in the following documents:
[3] E. J. Franzgrote, Use of a solid-state detector for the analysis of X-rays excited in silicate rocks by alpha-particle bombardment, Advances in X-ray analysis, 15 (1972) 388-406
[4] V. M. Radchenko et al., ²⁴⁴Cm based α-sources for space exploration, Radiochemistry, Vol. 41, No. 2 (1999) 155-158.

But these sources are used in the field of space research and do not have the confinement required for earth-borne experiments.

Further, the source known from document [3] is sealed by two alumina (Al₂O₃) membranes and these membranes therefore contain aluminum which is capable of inducing a parasitic fluorescence during PIXE and XRF measurements.

The sources known from document [4] are not even sealed. Further, they are prepared by high temperature condensation of metal curium vapor on silicon substrates in order to form compounds of the CmSi₂, Cm₂Si₃, CmSi and Cm₅Si type. They therefore contain silicon which is also capable of inducing parasitic fluorescence during PIXE and XRF measurements.

The source comprised by the device, object of the invention, does not have this drawback. In a preferred embodiment, it is further non-contaminating and has reliable and durable confinement, required for analyzing samples in locations where they are found.

Further, it is easy to recycle the radioactive material contained in this source.

Further, document [4] describes a multisource device, in which sources of small dimensions (in the shape of pellets) are juxtaposed. By design, in such a device, the activity of curium is distributed very unevenly. In order to obtain sufficient average activity for a good signal-to-noise ratio, each pellet should have a relatively larger activity than for a single source with a uniform distribution.

The source of the invention preferably has a ring shape where the activity is uniformly distributed over one of the faces of the support of the source, with which it is possible to reduce by a factor 2 or 3 the dose per unit surface of ionizing radiations which are received by the source support, as compared with a source of the type which is described in document [4].

Further it should be noted that a source according to the invention may be made which has the advantage of always being non-contaminating even after at least 18 months of use, and of not having any contamination by contact.

Further, the device of the invention may be made in an integrated and portable form. It may thereby be brought to sites, for example archeological sites, for which access is difficult or even impossible for heavy equipment.

### SHORT DESCRIPTION OF THE DRAWINGS

The present invention will be better understood upon reading the description of exemplary embodiments given hereafter, purely as an indication and by no means as a limitation, with reference to the appended drawings wherein:

FIG. 1 is a schematic and partial sectional view of a radioactive source example, which may be used in the present invention,

FIG. 2 is a schematic sectional view of an installation allowing electrochemical deposition of ²⁴⁴Cm in order to form this source,

FIG. 3 is a schematic sectional view of the source, placed in a casing, and

FIG. 4 is a schematic view of an exemplary PIXE-XRF analysis device according to the invention.

### DETAILED DISCUSSION OF PARTICULAR EMBODIMENTS

According to a preferred embodiment, the making of a device according to the invention comprises three distinct clearly identified steps:

1) making a ²⁴⁴Cm source support, comprising different parts: a ring of material made with chemical elements each having an atomic number less than 10, for example a ring of polyimide marketed as Kapton®, covered with a noble metal, for example gold, a lead shielding, an electrical contact between the gold and the lead on the edge of the support;

2) preparing a ²⁴⁴Cm source with a high rated activity of the order of 30 MBq, by electrodeposition of curium in an organic medium (dimethyl formamide or DMF) on the aforementioned support based on gold-coated Kapton®;

3) confining the radioactive material (²⁴⁴Cm) electrodeposited on the support in order to provide a character of “non-contaminating source” to the thereby produced source.

The inventors found that electrodeposition, more specifically electrodeposition in an organic medium, was a method particularly well adapted to making quantitative deposits of ²⁴⁴Cm (notably because of the low current density, of the short electrodeposition time, of the good adherence of the deposits and of the high electrodeposition yield for actinides).

Of course, the selection of the solvent forming the electrolyte is a crucial preliminary step.

In the case of the relevant preferred embodiment, this electrolyte should have not only good chemical compatibility with aqueous solutions of nitric acid (initial medium for ²⁴⁴Cm) but be also only composed of elements for which the atomic numbers Z are less than 10. Indeed, the active surface of the source must by no means be contaminated by elements capable of subsequently inducing parasitic fluorescence during PIXE-XRF measurements, even if these elements are in the form of traces.

Let us note that the sources mentioned in documents [3] and [4] do not meet this last recommendation because of the presence of aluminium, as Al₂O₃, in the first case and of the presence of silicon as CmₓSi_{y} in the second case.

In the relevant preferred embodiment, the ²⁴⁴Cm deposition method is therefore based on electrodeposition of curium in a dimethyl formamide (DMF) medium. The inventors estimate that the values of the ²⁴⁴Cm electrodeposition parameters in DMF are more or less directly applicable to electrodeposition of the other ions of actinides (notably Am, Pu, Np).

1) Making the ²⁴⁴Cm Source Support

The source support intended for electrodeposition of ²⁴⁴Cm in DMF comprises a solid Kapton® ring 2 (see FIG. 1) with a thickness of 1 mm, the external diameter of which is 24 mm and the internal diameter of which is 5 mm. This material was retained for its large resistance to irradiation.

On one of the faces of this solid Kapton® ring a fine gold layer 4 is deposited for which the thickness is less than 0.2 μm and is 0.1 to 0.2 μm for example, according to a standard method for metallization in vacuo. This gold layer will allow the Kapton® ring to provide the cathode function on which curium will be deposited by electrolysis (electroprecipitation).

It has been shown that such a gold thickness on the source support was sufficiently small so as not to induce significant parasitic X radiation, capable of perturbing the subsequent spectrometry measurements.

In FIG. 1, reference 4a represents the curium layer which will be deposited for obtaining an a and X radiation source according to the invention.

Instead of gold, another noble metal (platinum, silver . . . ) may be used for making the cathode. The use of noble metals for the electrodes is essential in order to prevent any risk of contamination of the deposited layer. In the case of making sources, sources of large purity may thereby be obtained, and parasitic fluorescence stemming from other components of the source may be avoided, which would risk masking the useful signal from the sample to be analyzed by PIXE-XRF analysis.

Before use, the source support in gold-coated Kapton® is heated to 150° C. in an oven for 30 minutes in order to increase adherence of the gold layer on the Kapton®. After cooling to room temperature, a lead ring 6 with a thickness of 0.5 mm, the external diameter of which is 25 mm and the internal diameter of which is 5 mm, is attached to the back of the source support. During the use of the source for PIXE-XRF measurements, this shielding provides strong attenuation of the X radiation from ²⁴⁴Cm (average energy of the order of 17 keV) in the direction of the detector.

Electric conduction between gold and lead, required for the electrodeposition operation, is provided by means of a resin 7 which is doped with metal silver particles (extrinsic conducting polymer) and deposited in several locations of the periphery of the source support.

2) Preparing the ²⁴⁴Cm Source

a) The Confinement Chamber

The ²⁴⁴Cm electrodeposition operations and the conditioning of the sources are performed in a glove box, or GB, marketed by the Jacomex® company, of class I (ISO 10648-2 standard), connected to the active network of a laboratory which is located in a controlled area. This GB is equipped with a system of inlet and outlet filters with an efficiency of 99.99%, and with gloves in Hypalon®, marketed by Piercan.

b) The Electrolysis Cell

The preparation of an annular source of ²⁴⁴Cm is carried out in an electrolysis cell in solid and polished Teflon®. This cell comprises the following components: a base, a chimney forming a reservoir, a central screw, a threaded crown and a rotating anode.

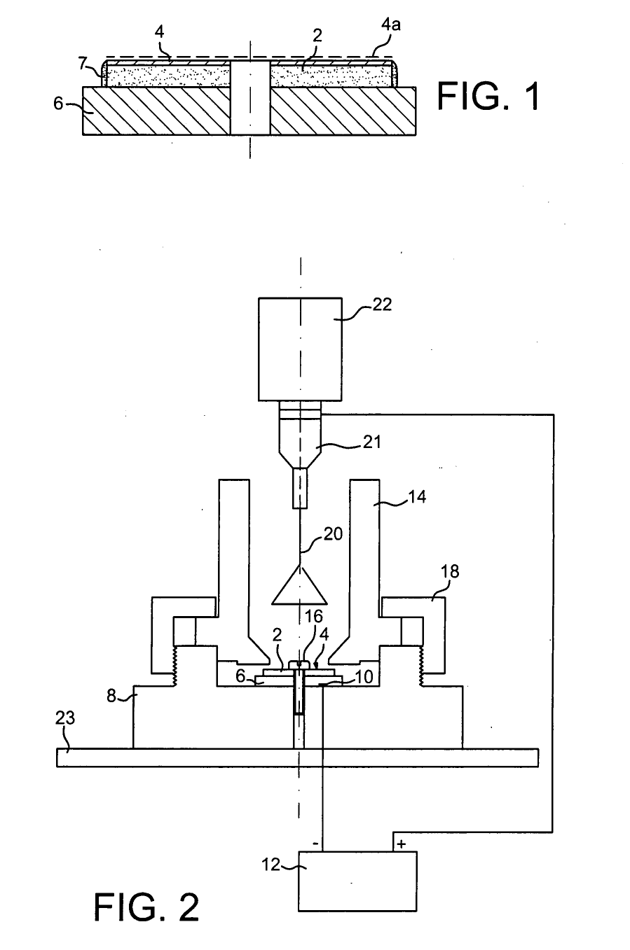

The base 8 (see FIG. 2) is intended to receive the annular source support (Pb/Kapton®/Au). It is equipped with a current supply lead provided with an electric contact 10 (metal spring). This contact exerts pressure against the lead layer of the source support when this support is immobilized at the bottom of the base of the cell. The current supply lead is connected to the negative pole of a direct current electric generator 12 of the LKB 2301 Macrodrive 1 type.

The chimney 14 forming a reservoir for the electrolyte has a useful volume of 10 ml. It is terminated by an open conical base, the diameter of which is 14 mm. This conical base has on the underside a rim forming a gasket, with a thickness of 1 mm, coming into contact with the gold surface of the source support.

The chimney is also provided with a groove (not shown) in which an insert (not shown) will be positioned. This insert is screwed into the internal edge of the base of the cell. With this, rotation of the chimney in the base of the cell may be prevented upon tightening the assembly.

The central screw 16 is in plastic or in Teflon®. Its diameter is 5 mm. It is intended to immobilize the source support on the base of the cell. The flat head of this screw has a diameter of 7 mm and also provides the seal by pressure at the centre of the source support.

The threaded crown 18 is in Teflon®. It provides by simple tightening the sealed assembly of the different constitutive components of the cell.

The rotating anode is formed by a platinum wire with a diameter of 1 mm, which is folded so as to form a triangle 20. The length of the base of this triangle is slightly larger than the external diameter of the radioactive deposit. This anode geometry is particularly effective for:
discharging the electrolysis gases which form at the surface of the electrodes,
providing renewal of the electrolyte at the surface of the cathode, and
uniformizing the current lines.

The anode is attached in the mandrel 21 of an electric motor 22 which is located above the cell. The electrical connection of the rotating anode, which is connected to the positive pole of the direct current electric generator mentioned above, is provided by a mercury contact (not shown).

In the thereby described configuration, the gold surface available for depositing curium is limited to (1.0±0.1) cm². The electrolysis cell is immobilized independently of the stirring motor on a platform 23 with adjustable height, of the “Support Boy” type. With this the distance between electrodes may easily be adjusted to the optimum value, i.e. (5.0±0.7) mm.

The electrodeposition parameters are relative to the preparation of the electrolyte and to the preparation of the ²⁴⁴Cm deposit.

A particular attention should be paid to the purity of the chemical products used for preparing the electrolyte. Table I shows the recommended values.

TABLE I

| Chemical products | Characteristics |
|---|---|
| DMF = Dimethyl | DMF > 99% |
| formamide | H₂O < 0.05% |
| HCON(CH₃)₂ | Density = 0.94 |
| ²⁴⁴Cm: aqueous | ²⁴⁴Cm > 99% |
| solution of Cm(NO₃)₃ | [²⁴⁵Cm + ²⁴⁶Cm + ²⁴⁸Cm + ²⁴⁰Pu] < 0.2% |
| Total activity < 30 MBq | |
| Volume < 0.1 ml | |
| Medium [HNO₃] = | |
| 0.1 mol/l | |
| H₂O (ultra-pure) | Resistivity: 18 MΩ · cm |

Electrodeposition is performed at room temperature. Heating the elements, notably the radioactive elements such as curium, at temperatures where dangerous reactions may occur, is thereby avoided.

The optimized experimental conditions of the electrodeposition are summarized in Table II. They make it possible to obtain ²⁴⁴Cm deposition yields which are larger than 95% for a total activity of ²⁴⁴Cm which is less than or equal to 30 MBq, for a nitric acid concentration in the electrolyte which is between 1.5×10⁻³ and 2.5×10⁻³ mol/l, and for [H₂O] less than 5%.

A moderate increase in the acid concentration beyond these limits induces a slight fall in the electrodeposition yield. For example, experiments have shown that for [H⁺]=3.5×10⁻³ mol/l and [H₂O]=3.5%, the electrodeposition yield of ²⁴⁴Cm is lowered to 85%.

Analysis of this table shows that with the selected method, it is possible to achieve quantitative deposits of ²⁴⁴Cm with strong activity by using a low current density value during a short electrolysis period.

It should be noted that such performances cannot be obtained with any known method, with an electrolyte free of major elements, for which the atomic numbers are larger than 10.

TABLE II

| Parameter | Value |
|---|---|
| Electrolyte volume | (3.0 to 3.5) ml |
| Speed of rotation of the | (200 ± 2) revolutions per |
| anode | minute |
| Inter-electrode distance | (5.0 ± 0.7) mm |
| Surface of the area of the | (1.0 ± 0.1) cm² |
| cathode | |
| Imposed current density | (4.0 ± 0.2 ) mA/cm² |
| Electrolysis duration | (15 ± 1) minutes |
| DMF | (95-98)% by volume |
| H₂O | (2-5)% by volume |
| [H⁺] of the electrolyte | (1.5-2.5) × 10⁻³ mol/l |
| (HNO₃) | |
| ²⁴⁴Cm | Activity < 30 MBq as |
| | Cm(NO₃)₃ |

3) Confinement of the ²⁴⁴Cm Source

a) Constitution of the Casing for Confining the Source

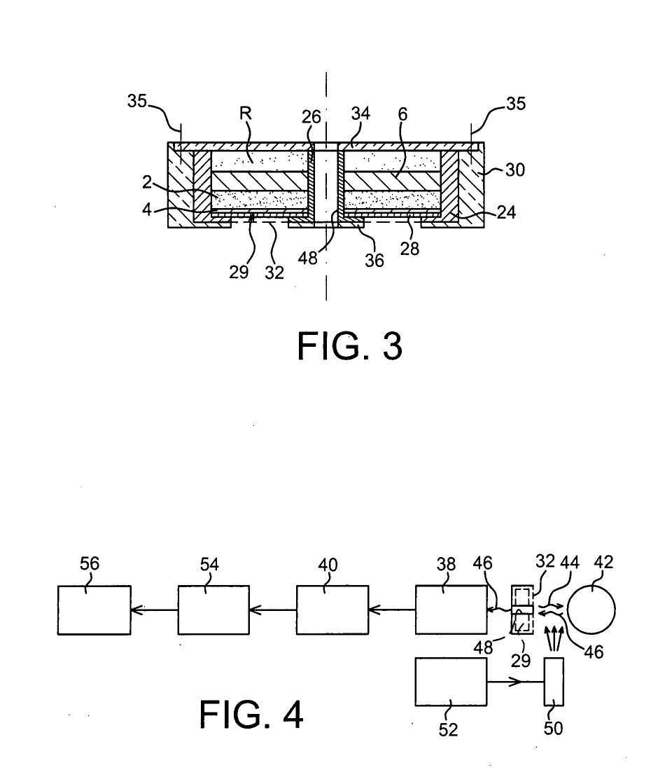

The ²⁴⁴Cm source extracted from the electrolysis cell is placed in a metal cylindrical confinement casing, which is made in zirconium. This casing comprises two portions, i.e. an external ring 24 (see FIG. 3) and a central ring 26 which are made integral with each other by means of an annular Kapton® window 28.

The active face of the source, the face which emits X and α radiations, will then be placed against this annular Kapton® window, the thickness of which is from 4-8 μm and which is adhesively bonded to the rings 24 and 26 with a two-component epoxy resin, marketed by 3M under reference DP 810.

Kapton® and the epoxy resin were selected for their excellent mechanical strength, their irradiation strength and the absence of elements which may generate parasitic fluorescence. The small thickness of the Kapton® window makes this window not very absorbent towards the a radiation while providing its barrier function for confining the radioactive material.

b) Confinement of the Source

A layer R of two-component epoxy resin marketed by 3M under reference DP 810 is cast on the lead shielding 6 in order to confine the ²⁴⁴Cm source.

After polymerization of the resin, the thereby confined source 29 is mounted in a PVC (polyvinyl chloride) casing 30, the front face of which includes an annular mechanical protection grid 32 in Nylon® wires facing the annular window 28. This grid 32 thus faces the active face of the source. Further, the rear face of the casing 30 is closed by a lid 34 also in PVC, which is screwed into the casing 30 by means of screws 35.

An annular part 36 in PVC, having the same inner diameter as the central ring 26, is adhesively bonded to the internal rim of the annular grid 32.

The thereby encased ²⁴⁴Cm source is then ready to be integrated to the X radiation detector of a portable spectrometric measurement chain.

An exemplary embodiment of a ²⁴⁴Cm source is given in the following.

The rated activity (28 MBq of ²⁴⁴Cm) of this source corresponds to the activity required for carrying out PIXE/XRF analyses with an acquisition time of 15 minutes.

The different steps which are required upon mounting the electrodeposition cell are described in Table III.

TABLE III

| Step | Operation | Comments |
|---|---|---|
| 1 | Place the annular | With the flat head of the |
| | source support 6 in | central screw, it is possible to |
| | the bottom of the cell | provide by pressure, the seal at |
| | 8 and then immobilize | the centre of the source |
| | it by means of the | support. The gold face of the |
| | central screw 16 in | source support will form the |
| | polymer material | bottom of the cell when the |
| | (plastic or Teflon ®). | Teflon ® chimney is set into |
| | | place (see step 2). |
| 2 | Introduce the Teflon ® | The implanted insert on the |
| | chimney forming a | internal rim of the bottom of |
| | reservoir 14 into the | the cell should slide in the |
| | bottom of the cell. | groove of the external edge of |
| | | the Teflon ® chimney. |
| 3 | Moderately screw in | The base of the Teflon ® chimney |
| | the threaded Teflon ® | will be applied against the gold |
| | crown 18. | face of the source support and |
| | | thereby provide the seal between |
| | | both parts. |

The inter-electrode distance is adjusted by means of the <<Support-boy>> type platform and an external rule, with a precision of ±0.5 mm. To do this, a first measurement of distance is carried out after having put the anode into contact with the flat head of the central screw. The anode is raised by a distance x by taking into account the height δ of the screw head, so as to obtain an inter-electrode distance x+δ equal to (5.0±0.7)mm.

In the following, the preparation of the electrolyte is explained.

The composition of the mother solution used is: [HNO₃]=0.1 mol/l, specific activity of ²⁴⁴Cm (as Cm(NO₃)₃) of the order of 350 MBq per gram of solution. The preparation of the electrolyte is carried out by introducing 80 μl of ²⁴⁴Cm mother solution into 2.764 g of DMF weighed beforehand (i.e. 2.940 ml of DMF). After homogenization, the mixture (i.e. 3.020 ml) is poured into the electrolysis cell.

Before starting with electrodeposition, a sample is taken in order to analyze the latter. By means of an automatic pipette with a single-use tip, 20 μl of the electrolyte are sampled, and then diluted in 14.496 g of DMF weighed beforehand (i.e. 15.421 ml of DMF). The thereby obtained dilution factor D₁ is equal to 771. After homogenization, 50 μl of this dilution is sampled before introducing them into 10 ml of a scintillation liquid, marketed by Packard as UltimaGold®.

Subsequent analysis of this fraction by the liquid scintillation method enables the ²⁴⁴ Cm activity contained in the electrolyte to be measured before electrodeposition.

Electrodeposition of ²⁴⁴ Cm comprises six steps.
Step 1. The electrolyte, i.e. DMF (a volume of the order of 3 ml) containing ²⁴⁴Cm, is introduced into the electrodeposition cell.
Step 2. The motor for stirring the anode is set into operation and one then proceeds with adjusting the speed of rotation to (200±2) revolutions per minute.
Step 3. By means of an external stabilized power supply connected to the electrolysis circuit, a direct current of 4.5 mA is imposed, the value of which is accurately measured by means of an amperemeter connected in series in the electrical circuit.

Electrodeposition is thereby performed in a galvanostatic mode (i.e. with constant current) and not in a potentiostatic mode (i.e. at constant potential difference). With an electrolytic deposition carried out under a constant potential difference, it is not possible to obtain a homogenous deposit of the actinide material layer because of current variations, which are likely to induce changes in the electrodeposition rate.

The potential difference between the electrodes (rotating anode and source support) is measured during the electrolysis by means of voltmeter having high input impedance of the order of 1 GΩ. Any anomaly during the electrodeposition operation is thus detected immediately by observing a sudden increase in voltage at the terminals of the electrodes.
Step 4. After an electrolysis time of (15±1) minutes, the electric circuit is cut off and the electrolyte of the cell is immediately emptied by withdrawing it by means of a Pasteur pipette in polyethylene. This electrolyte is then conditioned in a glass flask for its subsequent analysis.
Step 5. About 3 ml of isopropanol (propanol-2) are introduced into the cell in order to rinse the source support before emptying the cell. This operation is repeated a second time. As the isopropanol does not dissolve the ²⁴⁴Cm deposit (probably a curium hydroxide), it is unnecessary to recover the rinse effluent for subsequent analysis.
Step 6. After evaporation of the residual isopropanol of the last rinse on the active surface of the source, one proceeds with disassembling of the cell. The ²⁴⁴Cm source is extracted with precaution. The disassembling operations of the cell are carried out in the reverse order of the assembling operations described previously.

After electrolysis, 20 μl of the electrolyte are sampled by means of an automatic pipette with a single-use tip, which are diluted into 1.866 g of DMF weighed beforehand (i.e. 1.985 ml of DMF). The thereby obtained dilution factor D₂ is equal to 99. After homogenization, 50 μl of this dilution are sampled before introducing them into 10 ml of scintillation liquid (Ultimagold® liquid from Packard).

Subsequent analysis of this fraction by the liquid scintillation method enables the activity of ²⁴⁴Cm which is contained in the electrolyte after electrodeposition to be measured.

The electrodeposition yield (R_{cm}) of ²⁴⁴Cm may be computed by analyzing diluted fractions of the electrolyte before and after electrodeposition of ²⁴⁴Cm. The retained method of analysis is liquid scintillation counting (SL) in glass vials containing 10 ml of scintillation liquid of the Ultimagold® type (marketed by Packard).

The measurement apparatus used is of the type which is marketed by WALLAC under the reference Guardian 1414. The activity to be distributed in the vials to be analyzed should be less than 1 kBq in order to get rid of the problems related to the non-linearity of this apparatus for higher activities. Under these conditions, the α detection yield may attain 99.8%. A counting time of 600 s is sufficient in order to obtain appropriate counting statistics.

Preliminary experiments have shown that the presence of DMF in the selected scintillation liquid by no means perturbed the measurement. Therefore, there is no effect of the medium on the fluorescence loss.

The ²⁴⁴Cm electrodeposition yield may be computed from the following formula:

R_{Cm}=1−[D₂.P₁.C₂/D₁.P₂.C₁] (1)

In this formula, the following notations relate to the solution before electrodeposition of ²⁴⁴Cm:

D₁: dilution factor of the electrolyte

P₁: sampling of the dilution of the electrolyte for SL analysis C₁: counts per second of the sample P₁ (comparable to the activity).

The following notations relate to the solution after electrodeposition of ²⁴⁴Cm:

D₂: dilution factor of the electrolyte

P₂: sampling of the dilution of the electrolyte for SL analysis C₂: counts per second of the sample P₂ (comparable to the activity).

The following Table IV shows the results of the liquid scintillation analysis of different fractions allowing the ²⁴⁴Cm electrodeposition yield to be computed by means of formula (1), for the 28 MBq source.

TABLE IV

| Flask activity | | Volume activity | | Initial volume | Electrolyte | Initial |
|---|---|---|---|---|---|---|
| sl (Bq) | P₁ sample | (Bq/ml) | Dilution | activity | volume | activity |
| C₁ | for SL (μl) | dilution | (D₁) | (Bq/ml) | (ml) | (Bq) |
| 616 | 50 | 1.23 × 10⁴ | 771 | 9.5 × 10⁶ | 3.00(*) | 2.85 × 10⁷ |
| Flask | | Volume | | Initial | | |
| activity | | activity | | volume | Electrolyte | Initial |
| sl (Bq) | P₂ sample | (Bq/ml) | Dilution | activity | volume | activity |
| C₂ | for SL (μl) | dilution | (D₂) | (Bq/ml) | (ml) | (Bq) |
| 144 | 50 | 2.88 × 10³ | 99 | 2.88 × 10⁵ | 3.00 | 8.55 × 10⁵ |

(*)3.02 ml (electrolyte)-20 μl (sample)

After having computed the value of the electrodeposition yield, the activity A of the source is immediately inferred therefrom by means of the following formula:

A=Aᵢ×R_{cm} (2)

with:

Aᵢ: initial activity of ²⁴⁴Cm contained in the electrolyte, i.e. (28.5±0.6) MBq.

R_{cm}: ²⁴⁴Cm electrodeposition yield, i.e. (0.97±0.02).

Therefore: A=(27.6±0.8) MBq.

An exemplary portable spectrometric acquisition device according to the invention is described hereafter.

This device forms a measurement chain which comprises an X radiation detector 38 (see FIG. 4) of the SDD or silicon drift detector type, for example of the kind of those which are marketed by KETEK GmbH. This detector has a surface of 10 mm² and a resolution of 1.42 eV, at an energy of 5.9 keV.

It is associated with a multichannel analyzer 40, for example of the kind which is marketed by AMPTEK under reference Pocket MCA 8000, and with an electrical power supply for SDD (not shown), for example of the kind of those which are marketed by EIS.

The PVC casing 30 containing the ²⁴⁴Cm source 29 is attached to the detector 38 by means of an adaptation ring (not shown).

In FIG. 4, an object 42 which is intended to be analyzed by means of the device, is also seen. This object 42 is placed facing the grid 32 and therefore the source 29 and thus receives X and α radiations (reference 44 in FIG. 4) emitted by this source. The fluorescence X radiation 46 emitted by the object 42 then passes through the central aperture 48 of the source, more exactly the aperture of the ring 26 in order to reach the detector 38.

A scanning device 50 by means of helium gas is supplied by a bottle 52 containing this gas. This device is provided in order to scan the area between the grid 32 (and therefore the source 29) and the object 42 to be studied, by means of helium at a flow rate of 15 liters per hour.

The spectra obtained by the multichannel analyzer 40 are processed by a portable computer 54 and viewed on the screen 56 with which this computer is provided.

Examples of the use of the PIXE-XRF analysis device are given later on. Only qualitative results are provided, only intended for showing the application possibilities of the invention in various fields.

Quantitative measurements are also possible provided that the studied object is homogenous or has a known stratigraphy. The processing of the results may then be carried out after separating the respective PIXE and XRF contributions, by means of computation algorithms which are integrated to commercially available software packages, for example GUPIX of Maxwell et al. (1995) or GUPIX-X of Campbell et al. (2004).

On this matter, reference will be made to the following documents:
[5] J. A. Maxwell et al., The Guelph PIXE software package II, Nucl. Instrum. Methods B95 (1995), pages 407-421
[6] J. L. Campbell et al., PIXE and the Mars mission, 10th International Conference on PIXE and its applications, 4-8 Jun. 2004, Ljubljana (Slovenia).

The spectrum of the background noise of the PIXE-XRF analysis device is obtained by means of a sample of polyethylene, a material which exclusively consists of carbon and hydrogen and for which the chemical formula is [CH₂—CH₂]ₙ.

The observed lines are mainly due to elastic scattering of ²⁴⁴Cm X lines on polyethylene. The characteristic lines of gold (a plating material for Kapton® of the source support) are negligible.

The energy window which may be used for the PIXE/XRF analysis is located between 0 and 10 keV.

A multi-elementary standard, SCO-1 (Geostandards Newsletter, 1995), was used for checking the characteristics of the PIXE/XRF spectrometric measurement chain. On this matter, reference will be made to the following document:
[7] Geostandards Newsletter, Special Issue, 1995, page 35.

The calibration certificate associated with this reference shows that the material mainly consists of the following oxides: SiO₂ 62.78%; Al₂O₃ 13.67%; Fe₂O₃ 5.14%; K₂O 2.77%; MgO 2.72%; CaO 2.62%; Na₂O 0.90%; TiO₂ 0.63%.

Qualitative processing of the spectrometric data acquired for 15 minutes, provides identification of nearly all the alkali or metal cations, present as various oxides, right up to concentrations close to 1% for some of them (sodium and titanium).

The invention notably applies to the field of archeology.

The analysis of the elementary composition of the “black portion” of an ancient Greek vase often allows archaeologists to obtain information required for understanding the vase making technique. Thus, the spectrum obtained with a device according to the invention, for a fragment of ancient Greek pottery has shown the presence of elements such as silicon, aluminium, potassium, magnesium, iron, sodium and titanium. The acquisition time for the spectrum again was 15 minutes and the same applies for the other examples which follow.

The invention also applies to the field of geology.

A wall fragment of the Rouffignac cave (Dordogne, France) was measured. This cave, discovered in 1956, notably has a set of palaeolithic paintings, executed during the middle Magdalenian period. These paintings illustrate horses, ibexes, bisons, woolly rhinoceroses and especially about a hundred mammoths.

Analysis by X fluorescence of the composition of the materials used (probably manganese bioxide) first requires characterization of the underlying rock in order to correct the analysis results from the inevitable matrix effect.

PIXE/XRF spectra of a fragment of a screen block from the archeological site were obtained. The <<beige>> face of this block is characteristic of sound rock (fresh fracture produced during sampling) and the greyish face is characteristic of rock exposed to the internal atmospheric conditions of the cave.

The obtained spectra are quasi-similar. They show the presence of calcium, the main constituent of chalky rock, as well as the presence of aluminium and silicon, characteristic elements of clay (aluminosilicate hydrate). The presence of iron but the absence of manganese is noted. Analysis by X fluorescence of the prehistoric paintings based on MnO₂ should therefore not be perturbed by the chemical composition of the underlying rock.

A basalt powder of underwater origin was also measured.

The sample is a volcanic (basalt) rock, from the sea-bottom of the Pacific Ocean. This rock was milled and then pelletized in dry conditions, without any binder, so as to obtain a homogenous sample. A preliminary chemical (destructive) analysis showed that this rock had the following composition: SiO₂ 49.83%; Al₂O₃ 14.5%; Fe₂O₃ 11.32%; MgO 8.68%; CaO 11.17%; Na₂O 2.47%; TiO₂ 1.44%.

Each element identified by the chemical analysis may again be found with the qualitative analysis of this basalt sample by PIXE/XRF according to the invention.

The sludge of a water purification plant was also analyzed.

By knowing the chemical composition of the sludges of water purification plants, it is not only possible to detect the presence of pollutants which are harmful for the environment but also to better target their subsequent recycling. The PIXE/XRF method was tested with a device according to the invention on a sludge sample from a water processing plant from ONDEO. This sample was dried beforehand and then compacted with the press before analysis.

The obtained spectrometric data provided identification of metals, such as zinc, copper, iron, titanium, aluminum and magnesium. Sulphur and phosphorus were also detected. Elements from the alkali series (calcium and potassium) are also visible on the obtained spectrum. In this case, the PIXE/XRF analysis method discloses all its analytical power, by allowing detection of elements for which the atomic numbers range from 12 to 30.

The invention also applies to the field of sedimentology.

Measurement of the sanding-up rate of dams is conducted by means of specific gauges which use absorption of gamma radiation (E_{γ}=60 keV) from a ²⁴¹Am source. The response of these instruments is very sensitive to the chemical composition of the measured sand and measured muds. Knowing the change in their chemical composition over time is a good indicator for determining the periodicity of the calibration of the measurement gauges. As an example, an elementary analysis of a sand sample from the Génissiat dam (Ain, France) which had been taken, dried and compacted as a pellet, was conducted.

With the PIXE/XRF spectrum of this sample, elements may be detected for which the atomic numbers range from Z=11 (sodium) to Z=30 (zinc). Once more the PIXE/XRF method shows all its relevance here in a field such as chemical analysis in sedimentology.

The invention also applies to the field of metallurgy.

As an example, an inkwell from the 19^{th} century was analyzed, consisting of three portions: a cylindrical base threaded in its upper portion, a lid screwed onto this base and a glass inkwell, containing a residue of ink and which will be housed inside the metal base. Traces of wear of the plating layer show a yellowish material in places. The purpose of the analysis consists of determining the nature of the plating layer as well as that of the underlying material.

The obtained spectrum shows the presence of nickel, copper, zinc and calcium. It may be inferred that the yellowish alloy is brass (an alloy of copper and zinc) and that it is covered with nickel plating (greyish metal). The presence of calcium may be ascribed to external contamination.

The recycling of the source made according to the invention is now considered.

After its legal period of use, the future of the ²⁴⁴Cm source from the method according to the invention is easily manageable because the radioactive material may be easily recovered and purified so as to be possibly reused.

After extracting the source from its confinement casing, the ²⁴⁴Cm deposit is put back into solution by acid leaching by means of few hundred μl of HNO₃ with a concentration larger than 0.1 mol/l. For obvious reasons of radiation protection, this operation must absolutely be carried out in an installation identical to the one which was mentioned earlier (confinement chamber).

The purification step then consists of separating residual ²⁴⁴Cm (82% of the initial activity) from its descendant, ²⁴⁰Pu (period=6,563 years), which has built up during the period of use of the source. This Cm/Pu separation may be achieved according to the standard methods of extensive re-processing>>, well-known to chemists of the nuclear sector. Among the latter, the most well-known ones may be mentioned such as extraction by a solvent and extraction chromatography.

1. A source of alpha and X radiations, this source (29) comprising a support (2) consisting of a chemical element for which the atomic number is less than 10 or of a plurality of chemical elements each having an atomic number less than 10, which support is covered with a layer of noble metal, having a thickness less than 0.2 μm and on which a layer of a material selected from actinides is deposited.

2. The source according to claim 1, wherein the support (2) has the shape of a ring.

3. The source according to claim 1, wherein the material is ²⁴⁴Cm.

4. The source according to claim 1, wherein the activity of the material is comprised in the interval ranging from 5 MBq to 50 MBq.

5. The source according to claim 1, wherein the noble metal is selected from gold, silver and platinum.

6. A simultaneous PIXE-XRF analysis device, this device comprising a source (29) according to claim 1.

7. The device according to claim 6, wherein the source (29) is non-contaminating and the layer of the material is deposited on a face of the support (2), a so-called active face, said active face thus being able to emit alpha and X radiations, and the source further comprises a window (28) which is permeable to these alpha and X radiations, resistant to these radiations and able to shield the active face, this window exclusively consisting of a chemical element for which the atomic number is less than 10 or of a plurality of chemical elements each having an atomic number less than 10.

8. The device according to claim 7, wherein the window (28) is made in polyimide, diamond or DLC, i.e. diamond-like carbon.

9. The device according to claim 7, wherein the thickness of the window (28) is between 2 μm and 10 μm.

10. The device according to claim 6, further comprising an X fluorescence detector (38).

11. The device according to claim 10, wherein the detector (38) is placed in proximity to the source.

12. The device according to claim 10, wherein the support (2) includes an active face, on which the layer of the material selected from actinides is deposited, this support includes a hole and the detector (30) is placed facing this hole and the face opposite to the active face.

13. The device according to claim 12, wherein the support (2) has the shape of a ring and the detector (38) is placed facing the hole of this ring.

14. A method for making the source according to claim 1, wherein the layer of the material is formed by electrochemical deposition, from an organic electrolyte based on dimethyl formamide and containing ions of the material.

15. The method according to claim 14, wherein the electrochemical deposition is carried out in a galvanostatic mode.

16. The method according to claim 14, wherein the electrochemical deposition is carried out at room temperature.
